(19) United States
(12) Patent Application Publication
(10) Pub. No.: US 2015/0313206 A1
(43) Pub. Date: Nov. 5, 2015

(54) Hunting Blind

(71) Applicant: Michael Holland, Fayetteville, AR (US)

(72) Inventor: Michael Holland, Fayetteville, AR (US)

(21) Appl. No.: 14/697,173

(22) Filed: Apr. 27, 2015

Related U.S. Application Data
(60) Provisional application No. 61/986,312, filed on Apr. 30, 2014.

(51) Int. Cl. A01M 31/02

(52) U.S. Cl. CPC A01M 31/025

(57) ABSTRACT

The present invention provides a hunting blind that is configured to provide a user, preferably a hunter, with a natural blind cover or concealment to avoid detection by potential prey. The hunting blind includes a base portion that is preferably rectangular in shape that is removably mounted on a tree trunk by at least one fastener. The base portion is preferably integrally formed with a centrally located flange that extends upwardly and outwardly in relation to the base portion. The centrally located flange includes an opening therethrough that is configured to receive at least one tree branch therethrough. The centrally located flange further includes a fastener that allows the tree branch to be removably secured therethrough. In this way, the hunting blind provides a user with a natural ground blind while hunting on the ground or an elevated natural blind while utilizing a tree stand.

### CROSS REFERENCE TO RELATED APPLICATION

This application claims the benefit of U.S. Provisional Application No. 61/986,312 filed on Apr. 30, 2014. The above identified patent application is herein incorporated by reference in its entirety to provide continuity of disclosure.

### BACKGROUND OF THE INVENTION

### Field of the Invention

The present invention relates to hunting accessories. More specifically, the present invention pertains to an improved hunting blind that is removably mounted to a tree trunk to provide a user with a cover device to avoid detection by prey while hunting.

Hunting is the practice of killing or trapping living organisms or pursuing them with intent of doing so. Hunting wildlife or feral animals is most commonly done by people for food, recreation, or trade. One of the most important guidelines for successful hunting is locating suitable hiding places, wherein a hunter can hide behind something or stay in the shadows. Without careful planning and cover, it becomes very difficult to hunt prey. One of the most successful tactics for hunting is simply hunting from the ground. While hunting from the ground, many hunters employ ground blinds, which enable hunters to choose stand locations all through hunting seasons without any advance scouting or preparation.

Furthermore, another one of the more successful tactics for hunting is the use of a tree stand. Tree stands provide a user with a better view of the surrounding area and can reduce the amount of human scent lingering on the ground. However, although the elevated position is an advantage, hunters are also most vulnerable to being seen as animals, such as deer, have become wary of hunters and have learned to look upwards towards the skyline as a precaution. In addition, although ground blinds are a good source of concealment while hunting, natural blinds or covers of any type in the woods often provide the best source for concealment. Therefore, there exists a need for a hunting blind that provides a more natural blind to provide a better source for concealment while hunting.

The present invention provides a hunting blind that uses at least one tree branch to provide a natural blind for hunters to allow them to avoid detection while hunting. The hunting blind includes a base portion that is configured to be removably mounted to a tree trunk. The base portion includes a centrally located flange preferably integrally formed with the base portion having an opening therethrough. The opening is configured to receive at least one tree branch therethrough. The centrally located flange includes a fastener configured to removably secure the tree branch therein to provide cover and allow a hunter to avoid detection by prey.

### SUMMARY OF THE INVENTION

In view of the foregoing disadvantages inherent in the known types of hunting blinds now present in the prior art, the present invention provides a new and improved hunting blind wherein the same can be utilized for removably securing at least one tree branch to provide cover and avoid detection while hunting.

It is therefore an object of the invention to provide a new and improved hunting blind that has all of the advantages of the prior art and none of the disadvantages.

Another object of the present invention is to provide a new and improved hunting blind that includes a base portion and a centrally located flanged extending outwardly and upwardly therefrom.

Yet another object of the present invention is to provide a new and improved hunting blind configured to provide a cover device for a user to avoid detection by prey while hunting.

Still yet another object of the present invention is to provide a new and improved hunting blind, wherein said centrally located flange includes an opening configured to receive at least one tree branch therein.

A further object of the present invention is to provide a new and improved hunting blind, wherein said base portion includes at least one fastener configured to removably mount the hunting blind to a tree trunk.

Yet a further object of the present invention is to provide a new and improved hunting blind, wherein said centrally located flange includes a second fastener for removably securing said at least one tree branch in said opening.

Still yet another object of the present invention is to provide a new and improved hunting blind wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a side perspective of the present invention.

FIG. 2 shows another side perspective of the present invention in operation.

FIG. 3 shows a side perspective of a second preferred embodiment of the present invention.

### DETAILED DESCRIPTION OF THE INVENTION

References are made herein to the attached drawings. Like reference numerals are used throughout the drawings to depict like or similar elements of the hunting blind. For the purposes of presenting a brief and clear description of the present invention, the preferred embodiment will be discussed as used to hide a user while hunting to avoid detection by prey. The figures are intended for representative purposes only and should not be considered to be limiting in any respect.

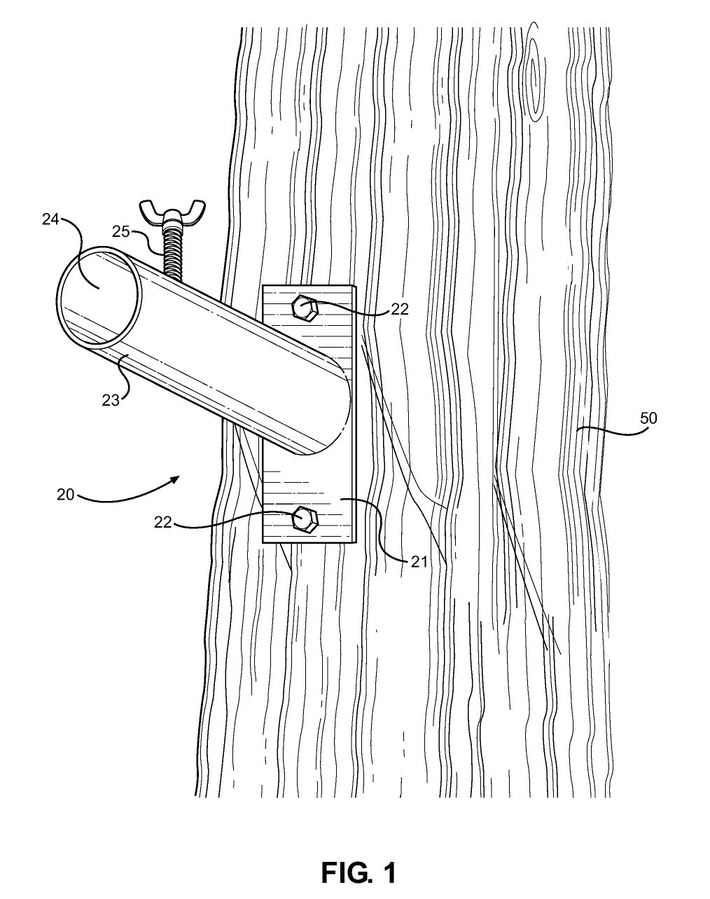

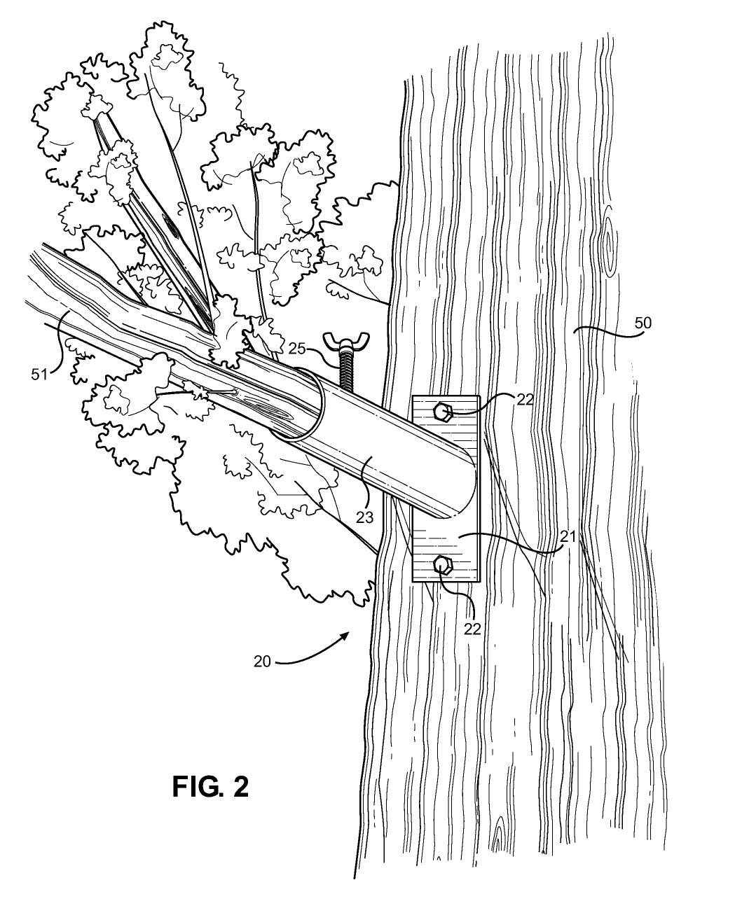

Referring now to FIGS. 1 and 2, there are shown a pair of side perspective views of the hunting blind. The hunting blind 20 is configured to provide a user (preferably a hunter) with a cover device designed to reduce the chance of detection by prey. The hunting blind 20 includes a base portion 21 that is configured to be placed against a tree trunk 50. Preferably, the base portion 21 is placed parallel to the longitudinal axis of the tree trunk 50, however it is contemplated that the base portion 21 can be placed in a perpendicular manner to the tree trunk 50 or a variety of other angles in relation to the tree trunk 50. In addition, the base portion 21 is preferably a rectangular shape, however, it is likewise contemplated that the base portion 21 can include a variety of shapes and sizes.

The base portion 21 includes at least one fastener 22 configured to removably secure the base portion 21 to the tree trunk 50. Preferably, the fastener 22 includes threaded elements, such as a screw, enabling a user to removably mount the base portion 21 thereto. In the illustrated embodiment, the base portion 21 includes a pair of openings in which a pair of fasteners 22 are positioned, however, it is contemplated that the base portion 21 can include just one fastener 22 or three or more fasteners 22 based on the judgment of one of ordinary skill within the art with the present disclosure before them. In addition, alternative embodiments include other suitable fasteners that allow the base portion 21 to be removably mounted on the tree trunk 50.

The base portion 21 further includes a centrally located flange 23, wherein the centrally located flange 23 includes an opening 24 therethrough configured to receive at least one tree branch 51 used to provide cover so as to allow the user to avoid detection by prey while hunting. The flange 23 is tubular in construction and may include a cylindrical construction as shown in the illustrated embodiment. The centrally located flange 23 extends outwardly and upwardly at an angle in relation to the base portion 21. It is contemplated that the length of the centrally located flange 23 is configured to support at least one tree branch 51 therein without the risk of the tree branch 51 falling out of the opening 24. Those of ordinary skill in the art will readily envision a variety of other preferable lengths of the centrally located flange 23, or substantially equivalent thereto, in which the tree branch 51 is supported.

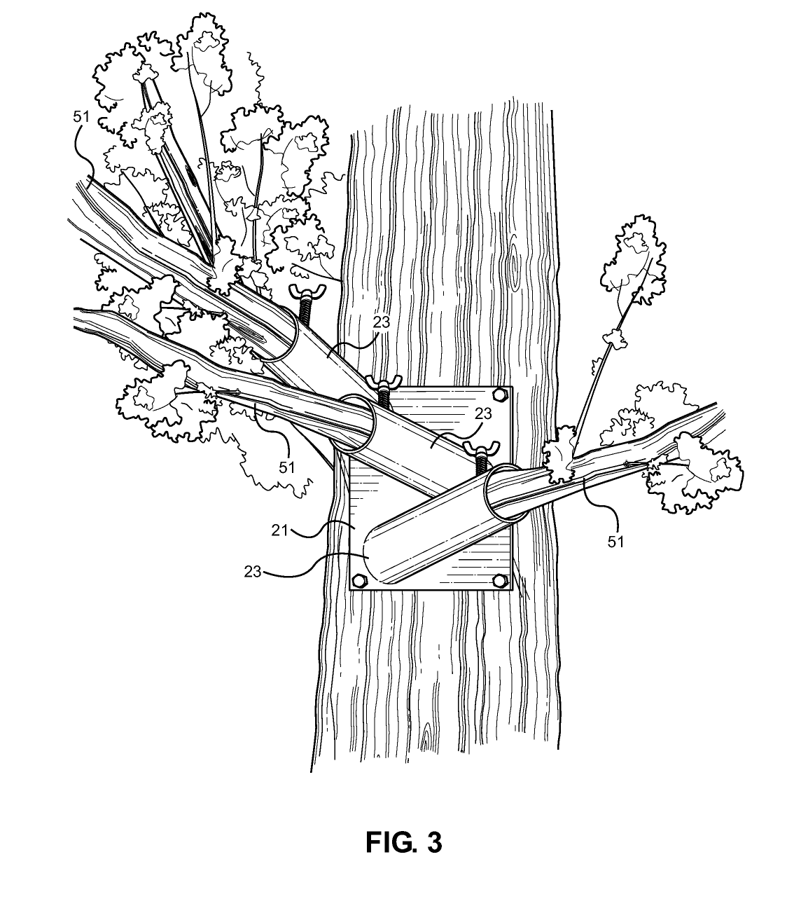

In addition, it is not desired at this time to limit the exact angle that the centrally located flange 23 extends from the base portion 21, rather, it is desired to disclose and claim a functional centrally located flange 23 for obtaining the results and the advantages described therein. It is contemplated that the angle is readily discernible to one of ordinary skill with the present disclosure before them and these modifications and variations are deemed to be within the scope of the invention embodiments described herein. In alternative preferred embodiments, like the embodiment illustrated in FIG. 3, the base portion 21 is larger and configured to support additional flanges 23 that extend outwardly and upwardly from the base portion 21 at an angle. In this way, the user is able to be further camouflaged by additional tree branches 51, thereby making the user harder to detect by prey.

The centrally located flange 23 comprises a fastener 25 that is configured to removably secure the tree branch 51 within the opening 24 of the centrally located flange 23. The fastener 25 extends into the interior volume of the flange 23 and is preferably radially positioned on the flange. Thus, the portion of the fastener 25 inside of the flange 23 secures the tree branch against the interior of the flange 23. Preferably, the fastener 25 includes a screw with a wing nut, however, it is contemplated that other fasteners 25 having threaded elements are appropriate, as well as other suitable types of fasteners 25. In this way, the user can stay hidden behind the tree branch 51 and the leaves thereon while hunting to avoid detection by prey.

The hunting blind 20 can be used while a user is on the ground and hiding behind a tree trunk 50. In some situations, a plurality of hunting blinds 20 can be used in a linear manner to hide the user from head to toe. The hunting blind 20 is also particularly advantageous when the user uses the hunting blind 20 in conjunction with a tree stand. Generally, when a user uses a tree stand, his location is exposed as there are not any tree branches and leaves to hide his location. However, the hunting blind can be removably mounted on the tree trunk 50 to provide cover and allow the user to avoid detection while using a tree stand.

The base portion 21 and the centrally located flange 23 are preferably integrally formed and unitary in structure, however, in some embodiments, the base portion 21 and the centrally located flange 23 are attached to one another via a strong epoxy glue or other suitable means of adhesive. The base portion 21 and the centrally located flange 23 are preferably composed from metal tubing, but no claim is made as to a specific material of construction.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A hunting blind, comprising:
a base portion configured to be placed against a tree trunk and removably fastened thereon by at least one first fastener;
a flange affixed on said base portion having an opening configured to receive and support at least one tree branch therein;
wherein said centrally located flange extends outwardly and upwardly from said base portion at an angle;
said centrally located flange including a second fastener configured to removably secure said at least one tree branch therein.

2. The hunting blind of claim 1, wherein said base portion is rectangular in shape.

3. The hunting blind of claim 1, wherein said second fastener includes a screw with a wing nut.

4. The hunting blind of claim 1, wherein said at least one first fastener includes a screw.

5. The hunting blind of claim 1, wherein said base portion includes additional said flanges that extend outwardly and upwardly from said base portion at an angle.
